(19) United States
(12) Patent Application Publication
(10) Pub. No.: US 2018/0250918 A1
(43) Pub. Date: Sep. 6, 2018

(54) HEATABLE LAMINATED GLASS COMPRISING A THIN INNER PANE AND A THIN OUTER PANE

(71) Applicant: SAINT-GOBAIN GLASS FRANCE, Courbevoie (FR)

(72) Inventors: Guenther SCHALL, KREUZAU (DE); Valentin SCHULZ, NIEDERZIER (DE)

(21) Appl. No.: 15/739,046

(22) PCT Filed: Dec. 15, 2016
(86) PCT No.: PCT/EP2016/081323

§ 371 Date: Apr. 30, 2018

(30) Foreign Application Priority Data
Dec. 16, 2015 (EP) 15200334.9

(51) Int. Cl. B32B 17/10

(52) U.S. Cl. CPC B32B 17/10229; B32B 17/10119; B32B 17/10036; B32B 17/10788; B32B 17/10761; B32B 17/1077; B32B 17/10137

(57) ABSTRACT

A vehicular laminated glass for separating a vehicle interior from an external environment is presented. The laminated glass includes inner and outer panes made of glass and having respective inner sides and outer sides, and a thermoplastic intermediate layer that bonds the inner side of the inner pane to the inner side of the outer pane. According to one aspect, the thickness of the inner pane is less than or equal to 1.4 mm, the thickness of the outer pane is less than or equal to 1.8 mm. An electrically heatable coating is applied on the inner side of the inner pane or the inner side of the outer pane.

The invention relates to a heatable laminated glass having a thin inner pane and a thin outer pane, a method for production thereof, and use thereof.

Laminated glasses are well known in the automotive sector. They usually consist of two glass panes with a thickness of 2 mm to 3 mm, which are bonded to one another by means of a thermoplastic intermediate layer. Such laminated glasses are used in particular as windshields and roof panels, but increasingly also as side windows and rear windows.

Currently the vehicle industry is striving to reduce the weight of vehicles, which is accompanied by reduced fuel consumption. A reduction in the weight of glazings, which can, in particular, be achieved by means of reduced pane thicknesses, can make a significant contribution to this. Such thin panes have, in particular, thicknesses less than 2 mm. However, despite the reduced pane thicknesses, the requirements for stability and break resistance of the panes must be ensured.

EP 2421704 B1 discloses a weight-reduced laminated glass pane, whose stone impact resistance is advantageously increased by the unsymmetrical laminate structure. Thus, the pane satisfies the high requirements for safety glazings in vehicles (ECE-R 43:2004) with regard to mechanical rigidity and stability as well as stone impact resistance.

In modern motor vehicles, heatable windshields, side windows, or rear windows are frequently used to keep the vehicle windows free of ice and condensation. The heating elements present in the pane should be hardly visible or not visible to the observer both for aesthetic reasons and for safety. The field of vision of windshields must, by law, not have any limitations to visibility. Heatable elements in windshields in the form of wires do, in fact, meet these legal requirements, but especially in darkness and with backlighting, the wires cause bothersome reflections. In recent years, especially in the automotive sector, panes with an infrared-reflecting electrically conductive coating are increasingly used. Such coatings have, on the one hand, good electrical conductivity, which enables heating of the pane, and, moreover, infrared-reflecting properties that reduce undesirable heating of the interior by solar radiation. These layer systems are thus of particular significance, not only in terms of safety relevant aspects such as unrestricted visibility, but also for ecological reasons such as a reduction in harmful emissions and an improvement of vehicle comfort.

Various examples of such functional coatings are, for example, IR-reflecting coatings or heatable coatings. Thermal-radiation-reflecting coatings are known, for example, from EP 2 141 135 A1, WO 2010115558 A1, and WO 2011105991 A1; heatable coatings, for example, from WO 03/024155 A2, US 2007/0082219 A1, and US 2007/0020465 A1. Moreover, in the area of heatable coatings, further improvements have occurred that effect a reduction in sheet resistance and thus enable higher heating output of the pane. WO 2013/104439 and WO 2013/104438 disclose electrically conductive coatings comprising a layer stack with at least two conductive layers as well as a plurality of dielectric layers. These coatings have very low sheet resistances, for example, 0.7 Ω/□ and are thus very well suited even for heating large-area panes. Usually, these coatings are applied to one of the glass panes of a laminated pane, in particular by cathodic sputtering (sputtering).

As a result of high environmental impacts and increasingly strict environmental protection regulations, it is desirable to reduce the harmful emissions of vehicles. This can occur, on the one hand, indirectly through weight reduction of vehicle components, and, on the other, through the reduction of fuel consumption. Among other things, equipment integrated in the vehicle, such as air conditioners or even heatable windows contribute to the fuel consumption of vehicles. Thus, it is particularly desirable to reduce the energy consumption of heatable vehicle panes.

WO 2015/158464 presents a laminated glass with an inner pane of a thickness of 0.1 mm to 0.4 mm. WO 2015058885 presents a laminated glass wherein a functional coating is arranged on a carrier layer.

The object of the invention is to provide a heatable laminated glass with reduced energy consumption with unchanged heating that has adequate stability and break resistance to be able to be used in the automotive sector, as well as a method for production thereof and use thereof.

The object of the present invention is accomplished according to the invention by a laminated glass according to claim 1, a method for production thereof according to claim 12, and use thereof according to claim 15. Preferred embodiments are disclosed in the subclaims.

The laminated glass according to the invention is preferably a laminated glass for vehicles (vehicular laminated glass). The laminated glass is intended, in an opening, in particular a window opening of a vehicle, to separate the interior from the external environment.

The laminated glass (or composite pane) according to the invention comprises at least one inner pane, one outer pane, and one thermoplastic intermediate layer, which bonds the inner pane to the outer pane, as well as an electrically heatable coating on the inner side of the inner pane or the inner side of the outer pane. The inner side of the inner pane is the surface of the inner pane turned in the direction of the thermoplastic intermediate layer, while the outer side of the inner pane is oriented toward the vehicle interior in the installed position.

The inner side of the outer pane is also oriented toward the thermoplastic intermediate layer, whereas, in contrast, the outer side of the outer pane is turned toward the vehicle's surroundings. The inner pane and the outer pane are made of glass. The thickness of the inner pane is less than or equal to 1.4 mm, and the thickness of the outer pane is less than or equal to 1.8 mm.

The combination of an electrically heatable coating with a laminated glass with such a thin inner pane and thin outer pane is particularly advantageous, since by a reduction of the material thickness, the mass to be heated is reduced, by means of which reduced energy consumption can be achieved with unchanged heating output. Also, the laminated glass according to the invention has sufficient stability and break resistance to be able to be used in the automotive sector.

The term “inner pane” means, in the context of the invention, the pane of the composite pane facing the interior (vehicle interior). “Outer pane” means the pane facing the external environment.

It has been demonstrated that a laminated glass with the thicknesses according to the invention for the outer pane and the inner pane has surprisingly high stability and break resistance, in particular scratch resistance and stone impact resistance. The inner pane can thus have a significantly lower thickness than previously generally assumed. The stability and break resistance of the laminated glass result from the selection according to the invention of the thickness of the outer pane and the pronounced asymmetry of the outer and the inner pane in terms of thickness. Surprisingly, the laminated glass according to the invention meets the high safety requirements in the automotive sector. These requirements are typically verified by standardized breakage, impact, and scratch tests, such as the ball drop test per ECE R43.

The laminated glass according to the invention is particularly preferably a windshield of a motor vehicle.

In a preferred embodiment, the inner pane is a pre-bent pane, i.e., a pane, that has been subjected to a thermal bending process prior to lamination to form the laminated glass. Of course, the inner pane can also, in principle, be a non-pre-bent pane, which, due to its low thickness, adapts itself to the shape of the outer pane during lamination. However, it is advantageous, in particular with so-called three-dimensional bending in multiple spatial directions, to use a pre-bent inner pane because the desired shape can then be obtained with low optical distortions. Since the bending process leaves a characteristic signature in the glass structure, the person skilled in the art can distinguish a pre-bent and a non-pre-bent pane from one another by visual inspection.

According to the invention, the thicker outer pane is pre-bent. The outer pane and the inner pane are preferably pre-bent congruently, in other words, they have the same pre-bending.

The inner pane can have, for example, a thickness of 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, or 1.4 mm.

The outer pane can have, for example, a thickness of 0.7 mm, 0.8 mm, 0.9 mm, 1.0 mm, 1.1 mm, 1.2 mm, 1.3 mm, 1.4 mm, 1.5 mm, 1.6 mm, 1.7 mm, or 1.8 mm.

The inner pane preferably has a thickness of 0.2 mm to 1.4 mm, particularly preferably 0.5 mm to 1.2 mm, in particular 0.6 mm to 1.0 mm. The outer pane preferably has a thickness of 0.7 mm to 1.4 mm, 0.7 mm to 1.8 mm, particularly preferably 1.2 mm to 1.7 mm. These ranges are advantageous in terms of lower weight of the laminated glass with high stability and break resistance. In an advantageous embodiment of the invention, the outer pane is not prestressed, in particular not prestressed chemically, and the thickness of the outer pane is in the range from 0.7 mm to 1.4 mm.

In terms of the stability of the laminated glass, a weight reduction of the pane, and a drop in the heating output required, the following thickness combinations have proved particularly advantageous:
a) outer pane 1.8 mm and inner pane 1.4 mm
b) outer pane 1.6 mm and inner pane 0.7 mm
c) outer pane 1.6 mm and inner pane 0.3 mm
d) outer pane 0.7 mm and inner pane 0.7 mm

In a particularly advantageous embodiment of the invention, the outer pane and the inner pane have different thicknesses, with the outer pane thicker than the inner pane. This asymmetry of thickness between the outer pane and the inner pane results in high stability.

In this sense, the highly asymmetric combination of an inner pane with a thickness less than or equal to 0.4 mm and an outer pane with a thickness greater than or equal to 1.5 mm has proved particularly advantageous in terms of the stability and stone impact resistance of the pane. Thus, an enormous savings in weight can be obtained compared to prior art pane thicknesses; and, nevertheless, a laminated glass with sufficiently high strength for use in the automotive sector, in particular as a windshield, can be obtained. Due to the reduced pane thickness, there is also a significant reduction in the energy to be used for heating the heated pane. Within this range, the combination of a 1.6-mm-thick outer pane and a 0.3-mm-thick inner pane Innerhalb should be emphasized as particularly advantageous relative to the effects mentioned.

In another preferred embodiment, the outer pane and the inner pane have the same thickness. Such a combination can be advantageous in terms of the greatest possible savings in weight, for example, with pane thicknesses of less than 1 mm in each case.

In an advantageous embodiment of the invention, the outer pane is a non-prestressed pane. The outer pane can be exposed to stresses such as stone impact. If a stone, in particular a small, sharp stone, strikes a glass pane, it can pass through the surface. In the case of a prestressed pane, the stone can thus penetrate into the tensile stress zone in the pane interior, resulting in shattering of the pane. A non-prestressed outer pane has a wider compressive stress zone and lower tensile stress in the interior and is thus less vulnerable to the impact of a sharp body. A non-prestressed outer pane is, consequently, overall, very advantageous in terms of the safety of the vehicle occupants.

In a preferred embodiment of the invention, the outer pane contains soda lime glass or borosilicate glass, in particular soda lime glass. Soda lime glass is economically available and has proved its value for applications in the automotive sector.

In an advantageous embodiment of the invention, the inner pane is a chemically tempered pane. Through tempering, the inner pane can be provided with special break stability and scratch resistance. For a very thin glass pane, as is provided as the inner pane according to the invention, chemical tempering is more suitable than thermal tempering. Since thermal tempering is based on a temperature difference between a surface zone and a core zone, thermal tempering requires a minimum thickness of the glass pane. Adequate stresses can typically be reached with conventional thermal tempering equipment at glass thicknesses starting from approx. 2.5 mm. With lower glass thicknesses, the values generally required for tempering values usually cannot be reached (cf., for example, ECE Regulation 43). In the case of chemical tempering, the chemical composition of the glass in the region of the surface is changed by ion exchange, wherein the ion exchange by diffusion is limited to a surface zone. Chemical tempering is, consequently, particularly suitable for thin panes. Chemical tempering is also commonly referred to as chemical prestressing, chemical hardening, or chemical toughening.

The stability of the inner pane can be improved by suitable values and local distribution of stresses that are produced by the storage of ions during chemical tempering.

The chemically tempered inner pane preferably has a surface compressive stress greater than 100 MPa, preferably greater than 250 MPa, and particularly preferably greater than 350 MPa.

The compressive stress depth of the pane is, in particular, at least one-tenth of its thickness, preferably at least one-sixth of its thickness, for example, approx. one-fifth of the thickness of the inner pane. This is advantageous in terms of the break resistance of the pane, on the one hand, and a less time-intensive tempering process, on the other. In the context of the invention, the term “compressive stress depth” refers to the depth measured from the surface of the pane, to which the pane withstands compressive stresses with an amount greater than 0 MPa. If the inner pane has, for example, a thickness of 0.3 mm, the compressive stress depth of the inner pane is preferably greater than 30 μm, particularly preferably 50 μpm, most particularly preferably between 100 μm and 150 μm.

The inner pane can, in principle, have any chemical composition known to the person skilled in the art. The inner pane can, for example, contain soda lime glass or borosilicate glass or be made of these glasses. Preferably, the inner pane should be suitable for being chemically tempered; and, in particular, have a suitable content of alkaline elements for this, preferably sodium. The inner pane can, for example, contain from 40 wt.-% to 90 wt.-% silicon oxide (SiO₂), from 0.5 wt.-% to 10 wt.-% aluminum oxide (Al₂O₃), from 1 wt.-% to 20 wt.-% sodium oxide (Na₂O), from 0.1 wt.-% to 15 wt.-% potassium oxide (K₂O), from 0 wt.-% to 10 wt.-% magnesium oxide (MgO), from 0 wt.-% to 10 wt.-% calcium oxide (CaO), and from 0 wt.-% to 15 wt.-% boric oxide (B₂O₃). The inner pane can also contain other components and impurities.

It has, however, been surprisingly demonstrated that certain chemical compositions of the inner pane are particularly suited for being subjected to chemical tempering. This is expressed in a high speed of the diffusion process, resulting in an advantageously low expenditure of time for the tempering process, and large tempering depths (compressive stress depths), resulting in stable and break resistant glasses. These compositions are preferred in the context of the invention.

The inner pane contains, in a preferred embodiment, an aluminosilicate glass. The inner pane preferably contains from 50 wt.-% to 85 wt.-% silicon oxide (SiO₂), from 3 wt.-% to 10 wt.-% aluminum oxide (Al₂O₃), from 8 wt.-% to 18 wt.-% sodium oxide (Na₂O), from 5 wt.-% to 15 wt.-% potassium oxide (K₂O), from 4 wt.-% to 14 wt.-% magnesium oxide (MgO), from 0 wt.-% to 10 wt.-% calcium oxide (CaO), and from 0 wt.-% to 15 wt.-% boric oxide (B₂O₃).

The inner pane can also contain other components and impurities. The inner pane particularly preferably contains at least from 55 wt.-% to 72 wt.-% (most particularly preferably from 57 wt.-% to 65 wt.-%) silicon oxide (SiO₂), from 5 wt.-% to 10 wt.-% (most particularly preferably from 7 wt.-% to 9 wt.-%) aluminum oxide (Al₂O₃), from 10 wt.-% to 15 wt.-% (most particularly preferably from 12 wt.-% to 14 wt.-%) sodium oxide (Na₂O), from 7 wt.-% to 12 wt.-% (most particularly preferably from 8.5 wt.-% to 10.5 wt.-%) potassium oxide (K₂O), and from 6 wt.-% to 11 wt.-% (most particularly preferably from 7.5 wt.-% to 9.5 wt.-%) magnesium oxide (MgO).

These preferred glass compositions have another surprising advantage in addition to the possibility of chemical tempering. Such panes are suitable for being congruently bent together with panes of conventional soda lime glass (also called normal glass). Responsible for this are similar thermal properties, such that the two types of glass are bendable in the same temperature range, namely approx. from 450° C. to 700° C. As is sufficiently well known to the person skilled in the art, congruently bent panes are particularly suited for being bonded to form a laminated glass because of their optimally matched shape. An inner pane with the preferred chemical composition is thus particularly well suited to be used in a laminated glass with an outer pane of a different composition, made in particular of soda lime glass.

However, the inner pane can, alternatively, also be a non-prestressed pane. In particular with very thin glass panes, the stress values that can be obtained through chemical tempering, and thus the stabilizing effect decreases increasingly. If the inner pane is not tempered, it contains, in a preferred embodiment, borosilicate glass. It has been demonstrated that particularly pronounced stability and break resistance can be achieved in this manner.

The thermoplastic intermediate layer contains at least one thermoplastic film and is formed, in an advantageous embodiment, by a single thermoplastic film. This is advantageous in terms of a simple structure and a low total thickness of the laminated glass. The thermoplastic intermediate layer or the thermoplastic film preferably contains at least polyvinyl butyral (PVB), ethylene vinyl acetate (EVA), polyurethane (PU), or mixtures or copolymers or derivatives thereof, which have proved their value for laminated glasses.

The thickness of the thermoplastic intermediate layer is preferably from 0.2 mm to 1.0 mm. For example, thermoplastic films of the standard thickness of 0.76 mm can be used.

The outer pane, the inner pane, and the thermoplastic intermediate layer can be clear and colorless, but also tinted or colored. The total transmittance through the laminated glass is, in a preferred embodiment, greater than 70%, in particular when the laminated glass is a windshield. The term “total transmittance” is based on the method specified by ECE-R 43, Annex 3, § 9.1 for testing the light transmittance of motor vehicle windows.

The laminated glass is preferably bent in one or a plurality of spatial directions, as is customary for motor vehicle window panes, wherein typical radii of curvature are in the range from approx. 10 cm to approx. 40 cm. The laminated glass can, however, also be flat, for example, when it is intended as a pane for buses, trains, or tractors.

The laminated glass according to the invention has an electrically heatable coating on the inner side of the inner pane or the inner side of the outer pane. The electrically heatable coating is preferably arranged on the outer pane. The outer pane, thicker in a preferred embodiment, which is also preferably made of normal glass, can be coated more easily and more economically from a technical standpoint, for example, by physical vapor deposition (such as sputtering), than the usually thinner inner pane. In particular, coating and chemical tempering can be combined only with difficulty from a technical standpoint. A coating applied before tempering disrupts the ion diffusion process during chemical tempering. Coating after chemical tempering changes the distribution of stress in the pane due to the typically high temperatures. The functional coating is preferably arranged on the inner side of the outer pane facing the thermoplastic intermediate layer, where it is protected against corrosion and damage.

The electrically heatable coating can also be deposited on the inner side of the inner pane, in particular when the inner pane is not chemically tempered.

The electrically heatable coating can extend over the entire inner side of the inner pane or the outer pane. However, alternatively, the electrically heatable coating can also extend over only part of the surface. The electrically heatable coating preferably extends over at least 50%, particularly preferably over at least 70%, and most particularly preferably over at least 90% of the surface of the transparent substrate.

Suitable material compositions of the electrically heatable coating can be found, for example, in WO 2013/104439 and WO 2013/104438.

Preferably, the electrically heatable coating comprises at least two functional layers that are areally arranged one atop another. Each functional layer comprises at least
the electrically conductive coating (2) has at least two functional layers (3) arranged one atop another and each functional layer (3) comprises at least
   one antireflection layer (4),
   above the antireflection layer (4), a first adaptation layer (6), and
   above the first adaptation layer (6), an electrically conductive layer (7), and
at least one antireflection layer (4) arranged between two electrically conductive layers (7) at least
   one layer of a dielectric material (9) having a refractive index less than 2.1, and

a layer of an optically highly refractive material (10) having a refractive index greater than or equal to 2.1.

The layers are arranged in the order indicated with increasing distance from the pane on which the coating is applied. A cover layer is arranged above the uppermost functional layer.

By means of the appropriate design of the electrically heatable coating, an advantageously reduced sheet resistance and associated improved reflection properties for the infrared spectrum and improved specific heating output are obtained. The optical properties of the transparent pane according to the invention with an electrically conductive coating satisfy the legal requirements for glazings in the automotive sector.

Preferably, the electrically heatable coating has sheet resistance of 0.4 ohms/square to 0.9 ohms/square, for example, 0.9 ohms/square, 0.7 ohms/square, or 0.5 ohms/square.

Preferably, the total layer thickness of all electrically conductive layers is between 50 nm to 60 nm.

Preferably, another antireflection layer is arranged above the topmost functional layer.

Preferably, the topmost and the bottommost antireflection layers are designed as layers of an optically highly refractive material with a refractive index greater than or equal to 2.1 and preferably contain at least one mixed silicon/metal nitride, particularly preferably a mixed silicon/zirconium nitride, such as aluminum-doped mixed silicon/zirconium nitride.

Preferably, the thickness of the layer of an optically highly refractive material is from 10% to 99%, preferably from 25% to 75% of the thickness of the antireflection layer, which includes the layer of optically highly refractive material.

Preferably, each antireflection layer arranged between two electrically conductive layers includes at least one layer of a dielectric material with a refractive index less than 2.1 and one layer of an optically highly refractive material with a refractive index greater than or equal to 2.1.

Preferably, the thickness of the antireflection layers arranged between the two electrically conductive layers is from 35 nm to 70 nm, preferably from 45 nm to 60 nm.

Preferably, the layer of an optically highly refractive material contains at least one mixed silicon/metal nitride, particularly preferably a mixed silicon/zirconium nitride, such as aluminum-doped mixed silicon/zirconium nitride.

Preferably, the layer of a dielectric material contains at least silicon nitride.

Preferably, each functional layer above the electrically conductive layer includes a second adaptation layer.

The electrically conductive coating preferably includes at least one smoothing layer, which is arranged below one of the first adaptation layers and wherein, preferably, each functional layer includes a smoothing layer below the first adaptation layer.

Preferably, the smoothing layer contains at least one noncrystalline oxide, preferably a mixed noncrystalline oxide, preferably a mixed tin/zinc oxide, such as antimony-doped mixed tin/zinc oxide, and preferably has a layer thickness of 3 nm to 20 nm, particularly preferably of 4 nm to 12 nm.

Preferably, the electrically conductive layer contains at least silver or a silver-containing alloy and preferably has a layer thickness of 8 nm to 25 nm.

Preferably, the first adaptation layer and/or the second adaptation layer contains zinc oxide ZnO_{1-δ} with 0≤δ≤0.01, such as, for example, aluminum-doped zinc oxide, and preferably has a thickness of 3 nm to 20 nm, particularly preferably of 4 nm to 12 nm.

Preferably, at least one functional layer, particularly preferably each functional layer includes at least one blocker layer that is arranged immediately above and/or immediately below the electrically conductive layer and which preferably contains at least niobium, titanium, nickel, chromium, or alloys thereof, particularly preferably nickel chromium alloys and which preferably has a layer thickness of 0.1 nm to 2 nm.

In an advantageous embodiment of the invention, the electrically heatable coating is connected to a voltage source via busbars and a voltage applied on the electrically conductive coating preferably has a value of 12 V to 15 V. The busbars serve for transferring electrical power. Examples of suitable busbars are known from DE 103 33 618 B3 and EP 0 025 755 B1.

The busbars are advantageously produced by printing a conductive paste. If the pane is bent after application of the electrically conductive coating, the conductive paste is preferably fired before the bending and/or during the bending of the pane. The conductive paste preferably contains silver particles and glass frits. The layer thickness of the fired conductive paste is preferably from 5 μm to 20 μm.

In an alternative embodiment, thin and narrow metal foil strips or metal wires are used as busbars, which preferably contain copper and/or aluminum; in particular, copper foil strips with a thickness of preferably 10 μm to 200 μm, for example, approx. 50 μm are used. The width of the copper foil strip is preferably 1 mm to 10 mm. The electrical contact between the electrically heatable coating and the busbars can be produced, for example, by soldering or by gluing with an electrically conductive adhesive. In addition, the metal foil strips or metal wires can be placed on the electrically heatable coating at the time of the stacking of the composite layers. In the subsequent autoclave process, a reliable electrical contact between the busbars and the coating is obtained through the action of heat and pressure.

As the supply line for contacting busbars in the interior of a composite panes, foil conductors are customarily used in the automotive sector. Examples of foil conductors are described in DE 42 35 063 A1, DE 20 2004 019 286 U1, and DE 93 13 394 U1.

Flexible foil conductors, sometimes also referred to as flat conductors or flat-band conductors, are preferably made of a tinned copper band with a thickness of 0.03 mm to 0.1 mm and a width of 2 mm to 16 mm. Copper has proved its value for such conductor tracks since it has good electrical conductivity as well as good processability into foils. At the same time, the material costs are low. Other electrically conducting materials that can be processed into foils can also be used. Examples for this are aluminum, gold, silver, or tin and alloys thereof.

The laminated glass can also be provided with an additional function, in that the thermoplastic intermediate layer has functional inlays, for example, inlays with IR-absorbing, UV-absorbing, coloring, or acoustic properties. The inlays are, for example, organic or inorganic ions, compounds, aggregates, molecules, crystals, pigments, or dyes.

The invention is further accomplished by a method for producing a laminated glass according to the invention, wherein

(a) the inner pane, the thermoplastic intermediate layer, and the outer pane are arranged areally atop one another in this order, and

(b) the inner pane and the outer pane are bonded to one another by lamination.

If the laminated glass is to be bent, at least the outer pane is subjected to a bending process prior to lamination.

In a preferred embodiment, the inner pane is also subjected to a bending process. This is, in particular, advantageous in the case of strong curves in multiple spatial directions (so-called three-dimensional bending).

Alternatively, the inner pane is not pre-bent. This is advantageous, in particular, in the case of inner panes with very low thicknesses since these have a foil-like flexibility and thus can be adapted to the pre-bent outer pane, without having to be pre-bent themselves.

The outer pane and the inner pane can be bent individually. Preferably, the outer pane and the inner pane are bent congruently together (i.e., at the same time and by the same tool), since, thus, the shape of the panes is optimally matched for the subsequently occurring lamination. Typical temperatures for glass bending processes are, for example, 500° C. to 700° C.

In a preferred embodiment, the inner pane is provided with chemical tempering. If necessary, the inner pane is cooled slowly after bending. Excessively rapid cooling generates thermal stresses in the pane that can result in changes in shape at the time of subsequent chemical tempering. Until cooling to a temperature of 400° C., the cooling rate is preferably from 0.05° C./sec to 0.5° C./sec, particularly preferably from 0.1° C./sec to 0.3° C./sec. By means of such slow cooling, thermal stresses in the glass that result in particular in optical defects as well as a negative impact on subsequent chemical tempering can be avoided. Further cooling can then be done even at higher cooling rates, since below 400° C., the risk of generating thermal stresses is low.

The chemical tempering is preferably done at a temperature of 300° C. to 600° C., particularly preferably of 400° C. to 500° C. The inner pane is treated with molten salt, for example, dipped in the molten salt. During the treatment, sodium ions of the glass are, in particular, replaced by larger ions, in particular, larger alkaline ions, thus creating the desired surface compressive stresses. The molten salt is preferably the melt of a potassium salt, particularly preferably potassium nitrate (KNO₃) or potassium sulfate (KSO₄), most particularly preferably potassium nitrate (KNO₃).

The ion exchange is determined by the diffusion of the alkaline ions. The desired values for the surface compressive stresses and compressive stress depths can, consequently, be set in particular by the temperature and the duration of the tempering process. Usual times for the duration are from 2 hours to 48 hours.

After the treatment with the molten salt, the pane is cooled to room temperature. After that, the pane is cleaned, preferably with sulfuric acid (H₂SO₄).

The thermoplastic intermediate layer is preferably provided as a film. The production of the laminated glass by lamination is done with customary methods known per se to the person skilled in the art, for example, autoclave methods, vacuum bag methods, vacuum ring methods, calendar methods, vacuum laminators, or combinations thereof. The bonding of the outer pane and the inner pane is usually done under the action of heat, vacuum, and/or pressure.

The invention further includes the use of a composite pane according to the invention in a vehicle, preferably a motor vehicle, particularly preferably a passenger car, in particular, as a windshield, side window, rear window or roof panel.

The invention is explained in detail in the following with reference to drawings and exemplary embodiments. The drawings are schematic representations and not true to scale. The drawings in no way restrict the invention.

They depict:

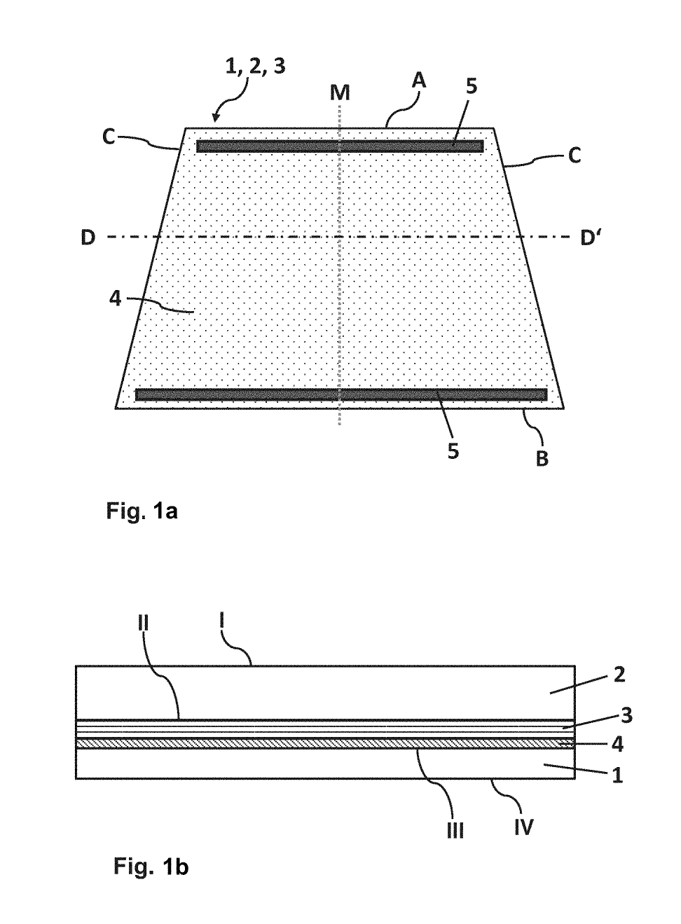

FIG. 1a and 1b a plan view and a cross-section through an embodiment of the laminated glass according to the invention, and

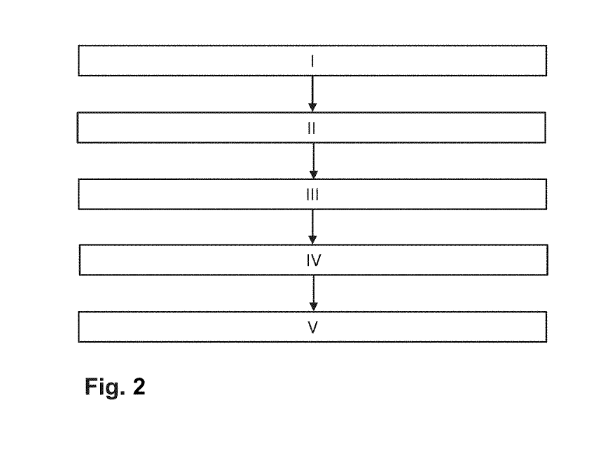

FIG. 2 a flowchart of an embodiment of the method according to the invention.

FIG. 1a and 1b depict a laminated glass according to the invention that comprises an inner pane 1 and an outer pane 2. The inner pane 1 has an inner side III and an outer side IV. The outer pane 2 has an inner side II and an outer side I. The inner sides II and III of the panes 1 and 2 are bonded to one another via a thermoplastic intermediate layer 3. An electrically heatable coating 4 is situated on the inner side Ill of the inner pane. The electrically heatable coating 4 comprises three conductive silver layers with dielectric layers arranged therebetween and has sheet resistance of R=0.9 Ω/□. The electrically conductive coating 4 was deposited on the inner pane 1 by magnetron sputtering. The intermediate layer 3 is formed from a single film made of PVB with a thickness of 0.76 mm. Two busbars 5 are electrically conductingly contacted on the electrically heatable coating 4, with one busbar 5 running substantially parallel to the roof edge A and one busbar 5 running substantially parallel to the engine edge B. A voltage of 14 V, which corresponds to the usual motor vehicle on-board voltage, is applied between the busbars 5. The laminated glass is heated by means of the resulting flow of current through the electrically heatable coating 4. The edges of the composite pane that run adjacent the A-columns after installation of the glazing in a motor vehicle body are referred to as lateral edges C. FIG. 1b depicts a cross-section of the arrangement of FIG. 1a along the section line D-D′. Between the lateral edges C runs, in the center of the laminated glass, the center line M, whose distance from one side edge C corresponds at each point to the distance from the opposite side edge C and which thus divides the laminated glass into two regions of equal size. The laminated glass is provided as a windshield of a motor vehicle. The laminated glass is, as is customary for motor vehicle windshields, three-dimensionally curved. This means that the pane has a curvature in multiple spatial directions. For the sake of simplicity, the laminated glass is, however, schematically depicted flat in the figure.

The heat-up time for heating the pane required to reach the maximum temperature was compared for the laminated glass according to the invention of FIGS. 1a and 1b and other laminated glasses according to the invention with a different pane thicknesses (Examples 1, 2, and 3, see Table 1) and for a laminated glass with prior art thicknesses (Comparative Example, see Table 1). The structure and the geometry of all laminated glasses were identical and corresponded to that described in FIGS. 1a and 1b; only the thickness of the outer pane and of the inner pane were varied, as reported in Table 1. The measurement was performed at an ambient temperature of 23° C. For the measurement of the maximum temperature, the point in the pane with the highest temperature was first determined. This is possible in a simple manner using thermography. The location of the pane with the highest temperature is the same for all Examples and the Comparative Example since the pane design is identical. Then, the amount of time to reach the maximum temperature of approx. 70° C. at this point is measured.

TABLE 1

| | Pane | Pane | Maximum | |
|---|---|---|---|---|
| | thickness | thickness | temperature | |
| | outer pane | inner pane | Tₘₐₓ | Time t |
| Comparative | 2.1 mm | 1.6 mm | 69.3° C. | 12 min |
| example | | | | |
| Example 1 | 1.8 mm | 1.4 mm | 70.0° C. | 10 min 50 sec |
| Example 2 | 1.6 mm | 0.3 mm | 69.9° C. | 4 min 45 sec |
| Example 3 | 0.7 mm | 0.7 mm | 70.0° C. | 3 min 15 sec |

Table 1 shows that by means of a reduction in the pane thicknesses according to the invention, the required heat-up time to a temperature of 70° C. can be reduced. A comparison of Example 1 and Comparative Example already yields a reduction of 9.7%. The reduction of the heat-up time is accompanied by a corresponding reduction in the energy consumption of the pane. With a further reduction in the pane thickness according to Examples 2 and 3, a further reduction in the heat-up time and, thus, in energy consumption is discernible. This was surprising and unexpected for the person skilled in the art. Furthermore, the laminated glasses according to Examples 1, 2, and 3 have stability and break resistance and are thus particularly well suited for use in the automotive sector. Moreover, by means of a reduction in pane thickness, a reduction in weight of the laminated glass is observed, which also results in reduced fuel consumption.

In a second experiment, the temperature distribution after 4 minutes of heat-up time was investigated along the section line D-D′ of FIG. 1b for Example (Example 1, see Table 2) and the Comparative Example (Comparative Example, see Table 2). The section line D-D′ cuts the center line M in the middle of the so-called B field of vision, wherein the portion of the B field of vision located between D-D′ and the roof edge A is exactly the same size as the portion of the B field of vision located between D-D′ and the engine edge B. The definition of the B field of vision and its determination on a given pane are sufficiently known to the person skilled in the art. In this regard, reference is made to Regulation 43 of the Economic Commission for Europe of the United Nations (ECE R 43) including all amendments up to Dec. 12, 2011 (Regulation 43, Revision 2 with Amendments 1-7), which the A field

TABLE 2

| | Minimum | Maximum | Temperature | |
|---|---|---|---|---|
| | temperature | temperature | deviation | Average |
| | Tₘᵢₙ along | Tₘᵢₙ along | ΔT along | temperature Tₐᵥ |
| | DD′ | DD′ | DD′ | along DD′ |
| Comparative | 29.2° C. | 29.6° C. | 0.4° C. | 29.4° C. |
| Example | | | | |
| Example 1 | 30.7° C. | 31.2° C. | 0.5° C. | 30.9° C. |

Table 2 confirms the results indicated in Table 1 in that the minimum temperature, the maximum temperature, and the average temperature can be increased with a laminated glass according to Example 1 according to the invention with the same heat-up time of 4 minutes compared to Comparative Example 1. The homogeneity of the temperature, indicated here by the temperature deviation along DU remains almost constant.

FIG. 2 depicts a flowchart of an exemplary embodiment of the method according to the invention for producing a laminated glass according to the invention comprising the steps:

I Bending of an inner pane 1 and an outer pane 2 together

II Chemical tempering of the inner pane 1 at 460° C. in a melt of KNO₃

III Washing the inner pane 1 with H₂SO₄

IV Arranging the inner pane 1, a thermoplastic intermediate layer 3, and the outer pane 2 one atop another

V Bonding the inner pane 1 to the outer pane 2 by lamination

Steps II and III are optional. However, if step II is done, step III should also be performed. If chemical tempering according to step II is not desired, it is possible to continue with step IV after step I.

The inner pane 1 and the outer pane 2 are provided in a flat initial state. The inner pane 1 and the outer pane 2 are subjected together to a bending process and congruently bent into their final three-dimensional shape.

Optionally, the inner pane 1 is chemically tempered after bending. For this, the inner pane 1 is cooled slowly after bending in order to avoid thermal stresses. A suitable cooling rate is, for example, 0.1 ° C./sec. The inner pane 1 is then treated for a period of a few hours, for example, 4 hours, at a temperature of 460° C. with a melt of potassium nitrate and, thus, chemically tempered. The treatment causes a diffusion-driven exchange of sodium ions for larger potassium ions over the surface of the glass. Thus, surface compresses stresses are generated. The inner pane 1 is then cooled and then washed with sulfuric acid to remove residues of the potassium nitrate.

Then, the thermoplastic intermediate layer 3 is arranged between the inner pane 1 and the outer pane 2. The stack consisting of the inner pane 1, the intermediate layer 3, and the outer pane 2 is bonded conventionally by lamination, for example, by a vacuum bag method.

### LIST OF REFERENCE CHARACTERS

(1) inner pane
(2) outer pane
(3) thermoplastic intermediate layer
(4) electrically heatable coating
(5) busbar
(A) roof edge
(B) engine edge
(C) lateral edges
(M) center line
D-D′ section line
(I) outer side of the outer pane
(II) inner side of the outer pane
(III) inner side of the inner pane
(IV) outer side of the inner pane

1.-15. (canceled)

16. A vehicular laminated glass for separating a vehicle interior from an external environment, the vehicular laminated glass comprising:
an inner pane, made of glass, comprising an inner side and an outer side;
an outer pane, made of glass, comprising an inner side and an outer side; and
a thermoplastic intermediate layer that bonds the inner side of the inner pane to the inner side of the outer pane,
wherein a thickness of the inner pane is in a range from 0.5 mm to 1.2 mm,
wherein a thickness of the outer pane is less than or equal to 1.8 mm, and
wherein an electrically heatable coating is applied on the inner side of the inner pane or on the inner side of the outer pane.

17. The vehicular laminated glass according to claim 16, wherein the vehicular laminated glass is a windshield.

18. The vehicular laminated glass according to claim 16, wherein the inner pane has a thickness of 0.6 mm to 1.0 mm.

19. The vehicular laminated glass according to claim 16, wherein the outer pane has a thickness of 0.7 mm to 1.8 mm.

20. The vehicular laminated glass according to claim 16, wherein the outer pane has a thickness of 1.2 mm to 1.7 mm.

21. The vehicular laminated glass according to claim 16, wherein the thermoplastic intermediate layer is formed by a single thermoplastic film.

22. The vehicular laminated glass according to claim 16, wherein the single thermoplastic film contains at least one of: a) polyvinyl butyral (PVB), b) ethylene vinyl acetate (EVA), c) polyurethane (PU), and d) mixtures or copolymers or derivatives of one or more of a)-c).

23. The vehicular laminated glass according to claim 16, wherein the thermoplastic intermediate layer has a thickness of 0.2 mm to 1 mm.

24. The vehicular laminated glass according to claim 16, wherein the electrically heatable coating comprises at least one electrically conductive layer that contains at least silver or an electrically conductive oxide.

25. The vehicular laminated glass according to claim 16, wherein the at least one electrically conductive layer has a thickness of 10 nm to 200 nm.

26. The vehicular laminated glass according to claim 16, wherein the inner pane is a chemically tempered pane, and wherein the electrically heatable coating is applied on the inner side of the outer pane.

27. The vehicular laminated glass according to claim 26, wherein the inner pane contains aluminosilicate glass.

28. The vehicular laminated glass according to claim 26, wherein the inner pane contains from 55 wt.-% to 72 wt.-% silicon oxide (SiO₂), from 5 wt.-% to 10 wt.-% aluminum oxide (Al₂O₃), from 10 wt.-% to 15 wt.-% sodium oxide (Na₂O), from 7 wt.-% to 12 wt.-% potassium oxide (K₂O), and from 6 wt.-% to 11 wt.-% magnesium oxide (MgO).

29. The vehicular laminated glass according to claim 16, wherein the inner pane is a non-prestressed pane and contains borosilicate glass.

30. The vehicular laminated glass according to claim 16, wherein the outer pane is a non-prestressed pane and contains soda lime glass.

31. A Method for producing a vehicular laminated glass, the method comprising:
arranging, respectively in a sequential order, an inner pane, a thermoplastic intermediate layer, and an outer pane, areally atop one another; and
bonding the inner pane and the outer pane to one another by lamination,
wherein the inner pane is made of glass, and comprises an inner side and an outer side,
wherein the outer pane is made of glass, and comprises an inner side and an outer side,
wherein the thermoplastic intermediate layer bonds the inner side of the inner pane to the inner side of the outer pane,
wherein a thickness of the inner pane is in a range from 0.5 mm to 1.2 mm,
wherein a thickness of the outer pane is less than or equal to 1.8 mm, and
wherein an electrically heatable coating is applied on the inner side of the inner pane or on the inner side of the outer pane.

32. The method according to claim 31, wherein the inner pane and the outer pane are bent together.

33. The method according to claim 31, wherein the inner pane is chemically tempered in a bent state of the inner pane.

34. A method, comprising:
providing a vehicular laminated glass according to claim 16; and
using the vehicular laminated glass in a motor vehicle, including in one or more of a windshield of a passenger car, a side window of a passenger car, a rear window of a passenger car, and a roof panel of a passenger car.
